(19) United States
(12) Patent Application Publication
(10) Pub. No.: US 2010/0245199 A1
(43) Pub. Date: Sep. 30, 2010

(54) MAGNETIC ANTENNA

(75) Inventors: Wen-Cheng LAI, Taipei (TW); Ching-Wen Hsue, Taipei (TW); Li-Ming Lo, Taipei (TW)

Correspondence Address: GOTTLIEB RACKMAN & REISMAN PC, 270 MADISON AVENUE, 8TH FLOOR, NEW YORK, NY, 10016-0601, US

(73) Assignee: National Taiwan University of Science and Technology

(21) Appl. No.: 12/495,841

(22) Filed: Jul. 1, 2009

(30) Foreign Application Priority Data
Mar. 26, 2009 (TW) 098110021

(51) Int. Cl. H01Q 19/02; H01Q 1/00

(52) U.S. Cl. 343/787

(57) ABSTRACT

A magnetic antenna is provided. The magnetic antenna includes an antenna; and a magnetic piece configured near the antenna with a distance therebetween.

### FIELD OF THE INVENTION

The present invention relates to an antenna. More particularly, the present invention relates to a magnetic antenna.

### BACKGROUND OF THE INVENTION

In recently modem times, due to prosperous progress of various wireless communication technologies and popularization of versatile technology products, there are lots of breakthroughs and newly developments achieved in the field of telecommunication industry. All types of the wireless communication equipments are extensively applied in a daily life for humans. Thus an antenna, indispensably configured in any wireless communication equipment, in particular to a plate antenna, draws tons of attentions because of its small-volume, easily manufactured and portable characters. There are conventionally many sorts of the plate antenna, including microstripe antennas, printed antennas and planar inverted-F antennas (PIFA).

However, no matter which sort an antenna is, its essential characters is inherently pre-settled. For instance, most of electromagnetic wave forms that the majority of the antennas radiate are omni-directional and unchangeable. But in many occasions, there is a strong demand to reinforce the strength of electromagnetic wave on a specific direction. For example, while one intends to engage a wireless communication by a mobile phone inside a tunnel, if the electromagnetic wave on a direction being parallel to the longitudinal route of the tunnel could be enhanced, or the form/pattern of electromagnetic wave could be altered as a directional wave beam directing to the longitudinal axis of the tunnel, the wireless communication quality for the mobile phone is consequently improved much better.

In patent issued as No. TW466,799, it provides an antenna having an electromagnetic interference suppressor which includes a composite magnetic member containing soft magnetic powder having oxide film layer and which covers a part of the periphery of the antenna. It is preferable that the electromagnetic interference suppressor covers one side or a half of the periphery of the antenna, whereby the effect of the radiation generated by the antenna and impacting on humans is reduced as small as possible. But the electromagnetic interference suppressor unitized by the TW466,799 patent has drawback that it is mainly designed for shielding or suppressing electromagnetic interference, although a part of wave form of antenna would be thus changed, the whole of wave form thereof is not directive yet.

From the above description, it accordingly becomes attractive and important to propose or invent a simple method for changing characters of an antenna, in particular to the pattern or wave form of an antenna. In order to overcome the drawbacks in the prior art, a magnetic antenna is thus provided. The particular design in the present invention not only solves the problems described above, but also is easy to be implemented. Thus, the invention has the utility for the industry.

### SUMMARY OF THE INVENTION

The present invention is mainly aimed to configure a magnetic material around the ground end of an antenna. It utilizes the character that the magnetic material could change a propagation path of an electromagnetic wave, so as to change a pattern from omni-direction to directional for an antenna and at the same time to enhance a gain thereof. While the surrounding of the antenna has none of the magnetic materials, the antenna maintains its original pattern. While a magnetic material is configured around the antenna, the pattern thereof is commenced to be affected and changed, so as to perform an effect of switching pattern thereof. The present invention could be widely applied to the telecommunication system including a mobile phone system and a base station system or a medical instrument. The pattern of antenna could be correspondingly adjusted with respect to different conditions and the gain on a specific direction thereof could be correspondingly increased by the invention presently proposed.

In accordance with the first aspect of the present invention, a magnetic antenna is provided. The magnetic antenna includes an antenna; and a magnetic piece configured near the antenna with a distance therebetween.

Preferably, the antenna has a straight-line structure and a feed-in line.

Preferably, the antenna is a monopole antenna.

Preferably, the antenna has an operating frequency of 2.4 GHz.

Preferably, the magnetic piece has a permeability being greater than 10.

Preferably, the magnetic piece further comprises a magnetic substance and a plastic substance.

Preferably, the magnetic piece has a thickness, and the distance over the thickness has a ratio greater than 1.

Preferably, the magnetic piece has a thickness, and the distance over the thickness has a ratio ranged from 14 to 15.

Preferably, the magnetic piece has a thickness, and the distance over the thickness has a ratio ranged from 35 to 36.

Preferably, a wireless communication device configured with the magnetic antenna.

Preferably, the wireless communication device is one selected from a group consisting of a mobile phone, a base station and a wireless transmit/receive unit.

In accordance with the second aspect of the present invention, a pattern changing method is provided. The pattern changing method for an antenna includes providing a magnetic unit; and configuring the magnetic unit being adjacent to the antenna with a distance therebetween.

Preferably, the magnetic unit has a thickness, and the distance over the thickness has a ratio greater than 1.

Preferably, the magnetic unit has a thickness, and the distance over the thickness has a ratio ranged from 14 to 15.

Preferably, of the magnetic unit has a thickness, and the distance over the thickness has a ratio ranged from 35 to 36.

In accordance with the third aspect of the present invention, a magnetic antenna is provided. The pattern changing device includes an antenna; and a magnetic piece having a permeability being greater than 10 and configured near the antenna.

Preferably, the pattern changing device is adjacent to the antenna with a distance therebetween.

Other objects, advantages and efficacy of the present invention will be described in detail below taken from the preferred embodiments with reference to the accompanying drawings, in which:

### BRIEF DESCRIPTION OF THE DRAWINGS

FIG. 1 which is a diagram illustrating the structure of the magnetic antenna according to the present invention;

FIG. 2 which is a diagram illustrating the E-plane radiation pattern of the magnetic antenna according to the present invention; and

FIG. 3 which is a diagram illustrating the gain of the magnetic antenna according to the present invention; and

FIG. 4 which is a diagram illustrating the pattern changing device according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

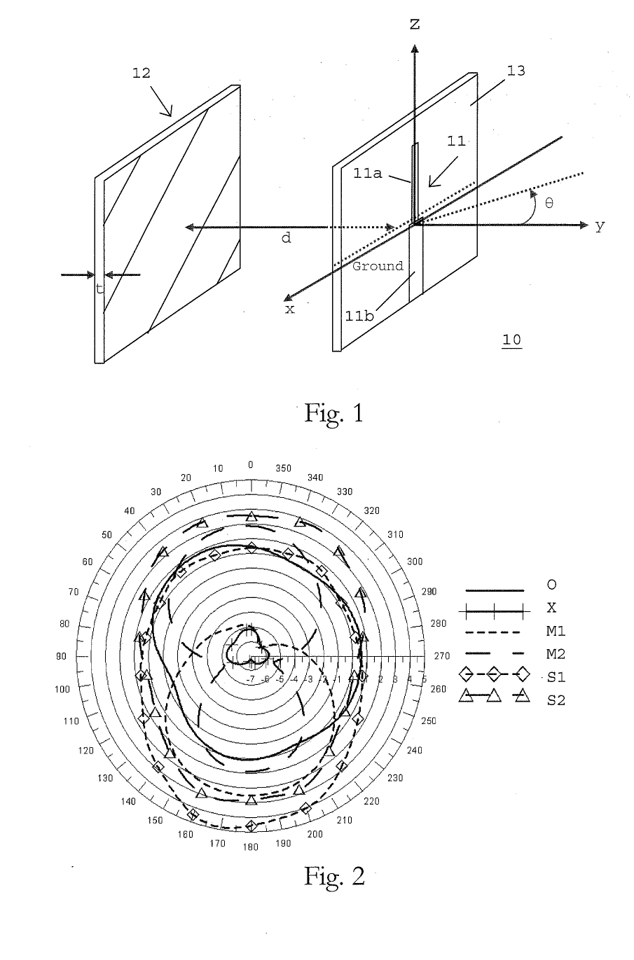

Please referring to FIG. 1, which is a diagram illustrating the structure of the magnetic antenna according to the present invention. In FIG. 1, the antenna 10 includes an antenna 11 and a magnetic piece 12 (also being a magnetic material or a magnetic unit). The antenna 11 disclosed in this present preferred embodiment is preferably a monopole micro-strip antenna, but is not limited thereby, secured on a substrate 13. The antenna 11 has a straight-line structure 11a and a feed-in line 11b. The straight-line structure 11a is used for being a resonant portion, also being a radiation portion, for a resonant/operating frequency at 2.4 GHz. The feed-in line 11b is used for feeding radiation signals into the straight-line structure 11a. The segment under the feed-in line 11b is a ground end of the antenna. The intersection of the straight-line structure 11a and the feed-in line 11b is to be an origin of a Cartesian coordinate where a X axis, a Y axis and a Z axis are respectively derived/branched therefrom. The substrate 13 is parallel to both the X axis and the Z axis and perpendicular to the Y axis. The included angle θ is an angle between a random point located on the X-Y plane and the Y axis.

The magnetic piece 12 is placed/located/configured around the ground end of the antenna 11 and has a distance d to the antenna 11. The thickness of the magnetic piece 12 is t and the permeability μ thereof is greater than 10 (H/m). The magnetic piece 12 is a kind of an absorber and is preferably a soft block composting of a magnetic substance and a plastic. The magnetic piece 12 is preferably utilized for shielding or absorbing electromagnetic wave interference at a specific frequency. Typically, the shielding or absorbing performance of the magnetic piece 12 is highly correlated with respect to the thickness and the composition thereof, and is also associated with respect to the permeability.

Please further directed to FIG. 2, which is a diagram illustrating the E-plane radiation pattern of the magnetic antenna according to the present invention. The thickness t of the magnetic piece 12 is pre-defined as 1 unit. The magnetic piece 12 is configured adjacent to/near/around the antenna 11 in parallel and located at the ground end of the antenna 11. Under such implementation, the E-plane radiation pattern of the antenna 11 with respect to different distance d computed by the numerical simulation and the experiment respectively could be accordingly obtained. As illustrated in FIG. 2, there are six patterns therein for the antenna 11, including the pattern O representing the original pattern without the magnetic piece 12, the pattern X representing the measured pattern at d=0 unit, the pattern M1 representing the measured pattern at d=14.2 unit, the pattern M2 representing the measured pattern at d=36.6 unit, the pattern S1 representing the simulated pattern at d=14.2 unit and the pattern S2 representing the simulated pattern at d=36.6 unit. It could be identified from the FIG. 2 that the original pattern O is an ordinary omni-direction pattern, and while the magnetic piece 12 is directly adhered or contacted the ground end of the antenna 11, the pattern X is the pattern having a the minimum area among patterns O, M1, M2, S1 and S2. For such condition, the magnetic piece 12 acts as a kind of absorbing substance, which could shield the electromagnetic wave emitted from the antenna 11. However, while the magnetic piece 12 is gradually separated away from the antenna 11 and the distance d is correspondingly increased, the pattern is apparently changed from the omni-direction pattern to the directional pattern. For instance, for patterns M1 and S1, while the distance is in the range from 14 to 15, in particular d=14.2 unit that is the ratio of the distance d over the thickness t of the magnetic piece 12 is 14.2, the maximum gain occurs at θ=180° and the patterns M1 and S1 apparently becomes the directional pattern. For patterns M2 and S2, while the distance is in the range from 35 to 36, in particular d=36.6 unit that is the ratio of the distance d over the thickness t of the magnetic piece 12 is 36.6, the maximum gain occurs at θ=0° and the patterns M2 and S2 apparently becomes the directional pattern and has significant reflective phenomenon than other patterns. Thus one could simply identify from patterns X, O, M1, M2, S1 and S2 in FIG. 2 that the electromagnetic wave of the antenna 11 could be accordingly changed from omni-direction pattern to directional.

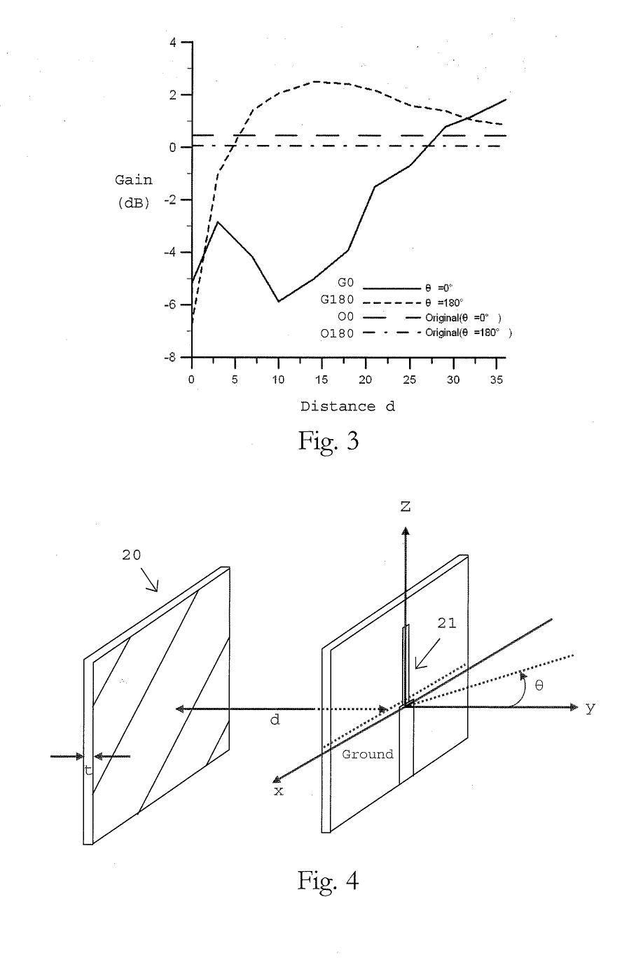

Please keep referring to FIG. 3, which is a diagram illustrating the gain of the magnetic antenna according to the present invention. The thickness t of the magnetic piece 12 is again pre-defined as 1 unit. The magnetic piece 12 is configured adjacent to/near/around the antenna 11 in parallel and located at the ground end of the antenna 11. Under such implementation, the gain (dB) of the antenna 11 with or without the magnetic piece 12 configured with respect to different distance d could be measured respectively at θ=0° and θ=180° by experimenting. There are four curves of gain in FIG. 3, including the curve O₀ representing the original gain measured at θ=0° without the magnetic piece 12 configured, the curve O₁₈₀ representing the original gain measured at θ=180° without the magnetic piece 12 configured, the curve G₀ representing the gain measured at θ=0° with the magnetic piece 12 configured and the curve G₁₈₀ representing the gain measured at θ=180° with the magnetic piece 12 configured. One is comprehended from the curve G₁₈₀ in FIG. 3 that the gain of the antenna 11 is persistently increased toward the direction of θ=180°. At the same time, from the curve G₀ in FIG. 3, the gain toward the direction of θ=0° is decreased continuously. Thus, one could simply identify from curves G₀ and G₁₈₀ in FIG. 3 while the distance d is kept residing in the range of 10 unit to 15 unit that is the ratio of the distance d over the thickness t of the magnetic piece 12 is ranged between 10 unit and 15 unit, in particular from 14 unit to 15 unit, a maximum value and a minimum value are respectively reached, and vice versa, while the distance d is kept residing in the range of 31 unit to 36 unit that is the ratio of the distance d over the thickness t of the magnetic piece 12 is ranged between 31 unit and 36 unit, in particular from 35 unit to 36 unit, a maximum value and a minimum value are respectively reached. This is at the moment while the gain in the curve G₁₈₀ toward the direction of θ=180° is gradually decreased, the gain in the curve G₀ toward the direction of θ=0° is increased gradually.

Therefore, by placing/locating the magnetic piece 12 around/near the antenna 11, the electromagnetic wave for wireless communication generated by the antenna 11 could be thus shielded, whereby the radiation pattern of the antenna 11 is changed to render the original omni-direction pattern of the antenna 11 transited to the directional pattern. At the same time, the gain at a specific direction is correspondingly increased, which benefits/enhances the transmitting/receiving performance of the antenna 11 at the specific direction. The present invention could be applied to various wireless communication devices, such as a mobile phone, a base station or a wireless transmit/receive unit. In addition, the present invention could be also applied to rescue/reinforce the communications with poor quality, such as the communications within the tunnel, within the mountainous area or within the region having insufficient numbers of base stations or the emergent communications.

Please keeping directed to FIG. 4, which is a diagram illustrating the pattern changing device according to the present invention. The pattern changing device 20 illustrated in FIG. 4 is mainly a magnetic piece having a permeability μ>10 (H/m). The pattern changing device 20 is placed/located/configured adjacent to/near/around the antenna 11 in parallel and located at the ground end of the antenna 11. The thickness of the pattern changing device 20 is t, which could be utilized to shield the electromagnetic wave emitted from the antenna 11, so as to change the radiation pattern from omni-direction pattern to directional.

The present invention could be at least applied to the circumstances as follows. (1) The circumstance when one encounters an environment having poor communication quality while using the mobile phone. For instance, while one communicates in a tunnel, in a mountainous area or in a region having insufficient numbers of base stations. The magnetic antenna or the pattern changing device according to the present invention could be applied to change the pattern of the antenna from omni-direction to directional so as to enhance/reinforce the strength of electromagnetic wave on a specific direction. (2) One encounters an emergent condition, for instance, while the mobile phone has low battery or lower transmitting/receiving power. The magnetic antenna or the pattern changing device could be applied to change the pattern of the antenna and to enhance the gain thereof so as to activate the mobile phone. (3) The present invention could be also applied to a base station. Conventionally, the base station is a transmit/receive unit using a point-to-point scheme. The present invention could be applied thereinto to enhance the gain at a specific direction, so as to enhance the directivity of the base station. (4) The present invention could be applied to the medical instruments to mitigate the interference thereamong.

While the invention has been described in terms of what is presently considered to be the most practical and preferred embodiments, it is to be understood that the invention needs not be limited to the disclosed embodiments. Therefore, it is intended to cover various modifications and similar configurements included within the spirit and scope of the appended claims, which are to be accorded with the broadest interpretation so as to encompass all such modifications and similar structures.

What is claimed is:

1. A magnetic antenna, comprising:
an antenna; and
a magnetic piece configured near the antenna with a distance therebetween.

2. The magnetic antenna according to claim 1, wherein the antenna has a straight-line structure and a feed-in line.

3. The magnetic antenna according to claim 1, wherein the antenna is a monopole antenna.

4. The magnetic antenna according to claim 1, wherein the antenna has an operating frequency of 2.4 GHz.

5. The magnetic antenna according to claim 1, wherein the magnetic piece has a permeability being greater than 10.

6. The magnetic antenna according to claim 1, wherein the magnetic piece further comprises a magnetic substance and a plastic substance.

7. The magnetic antenna according to claim 1, wherein the magnetic piece has a thickness, and the distance over the thickness has a ratio greater than 1.

8. The magnetic antenna according to claim 1, wherein the magnetic piece has a thickness, and the distance over the thickness has a ratio ranged from 14 to 15.

9. The magnetic antenna according to claim 1, wherein the magnetic piece has a thickness, and the distance over the thickness has a ratio ranged from 35 to 36.

10. A wireless communication device configured with the magnetic antenna as claimed in claim 1.

11. The wireless communication device according to claim 10 being one selected from a group consisting of a mobile phone, a base station and a wireless transmit/receive unit.

12. A pattern changing method for an antenna, comprising:
providing a magnetic unit; and
configuring the magnetic unit being adjacent to the antenna with a distance therebetween.

13. The pattern changing method according to claim 12, wherein the magnetic unit has a thickness, and the distance over the thickness has a ratio greater than 1.

14. The pattern changing method according to claim 12, wherein the magnetic unit has a thickness, and the distance over the thickness has a ratio ranged from 14 to 15.

15. The pattern changing method according to claim 12, wherein of the magnetic unit has a thickness, and the distance over the thickness has a ratio ranged from 35 to 36.

16. A pattern changing device, comprising:
an antenna; and
a magnetic piece having a permeability being greater than 10 and configured near the antenna.

17. The pattern changing device according to claim 16, wherein the magnetic piece is adjacent to the antenna with a distance therebetween.
